(19) United States
(12) Patent Application Publication
(10) Pub. No.: US 2013/0054404 A1
(43) Pub. Date: Feb. 28, 2013

(54) SYSTEM AND METHOD FOR WEBSITE SYNCHRONIZATION

(71) Applicant: Duniel Garcia, Hialeah, FL (US)

(72) Inventor: Duniel Garcia, Hialeah, FL (US)

(21) Appl. No.: 13/639,968

(22) PCT Filed: Apr. 8, 2010
(86) PCT No.: PCT/US10/30344

§ 371 Date: Oct. 8, 2012

(51) Int. Cl. G06F 17/00; G06Q 30/08; G06Q 30/00

(52) U.S. Cl. 705/26.3; 705/26.8; 715/234

(57) ABSTRACT

The invention relates to a system and method that allows a user to list or import information to a master website, where the master website then lists that information at multiple third party websites. Further, the system and method of the invention allows the user to update information in the master website in real time or for later batch processing, where the master website then updates the item information in the third party websites. Additionally, the system and method can automatically update the master item list of the master website in response to information from the third party websites, and then update the information across all of the third party websites. In one embodiment, the user lists or imports items for sale on a master item list at one master website, where the master website then lists that item on behalf of the user for sale at multiple e-commerce websites.

### FIELD OF THE INVENTION

This application relates generally to a system and method for the synchronous listing and management through a master website of information at a plurality of websites. One embodiment of the invention comprises the synchronous listing and management of items offered for sale at a plurality of electronic (“e-commerce”) websites.

### BACKGROUND OF THE INVENTION

The Internet has revolutionized the way that people communicate and share information. With a few key strokes, a person can share information around the world in merely seconds. In most cases, the person with the information to share must set up his/her own website and upload that information, or else find an existing website to upload the information. Various sites host various types of information. Sites such as Facebook™ allow for social networking where users can upload pictures for sharing. Other sites, such as YouTube® and eBaumsWorld™, host videos for sharing. In the usual manner, the user must set up an account on these sites and then upload the information at each separate site.

The website Pikchur.com allows users to upload pictures for sharing and then have those pictures uploaded onto a plurality of different websites, such as social networking sites. TubeMogul.com performs a similar function with the listing of videos, where a user can upload a video onto TubeMogul.com and then have it shared on a plurality of other sites.

The Internet however is useful for much more than social networking and is becoming a major consideration in retailing. The U.S. Census Bureau of the Department of Commerce estimated that U.S. retail e-commerce sales for businesses to consumers (“B to C”) for the fourth quarter of 2009 increased 4.5% over the third quarter of 2009 to $35.9 billion, while total retail sales increased 2.1% for the same period over the third quarter of 2009, and constituted 3.8% of total sales. See QUARTERLY RETAIL E-COMMERCE SALES 4th QUARTER 2009, U.S. Census Bureau News, Thursday, Feb. 16, 2010. Worldwide, there are an estimated 1.7 billion internet users, but only about 253 million in North America. The potential for worldwide sales over the Internet are tremendous.

More and more businesses are operating websites to advertise and sale their items and services. While many websites offer substantially the same products offered at a retailer's “bricks and mortar” stores, many other websites allow individual users to offer their own items and services for sale online. While the following discussion focuses on the offering of items for sale, that is not intended to limit the invention and it should be understood that information and items may be offered for lease, sharing or auction, or services may be offered for sale, in substantially the same manner according to the invention.

Typically, an individual user that wants to place an item for sale on multiple websites must set up an account at each website, list each item separately on each website and check for sales at each individual website. Additionally, if the user sells the item at one website, he/she may have to update or remove the listing from the other websites if the availability of the offered item becomes limited or becomes sold out. This can be time consuming for the seller and can lead to unhappy consumers if not performed consistently or promptly.

U.S. Pat. No. 6,115,641, titled “Systems and Methods For Facilitating the Exchange of Information Between Separate Business Entities” and issued to Brown et.al., the content of which is herein incorporated by reference, discloses a computer based catalog system for automatically distributing product information to members of a network. A computer based product catalog system is provided for automatically distributing product information and which allows for automatic updating of descriptions of products in manufacturer's catalogs, facilitating prompt dissemination of product information from manufacturers to others downstream in the distribution chain. Systems for synchronizing fabrication and supplier schedules are also disclosed along with synchronization of accounting and billing systems, access to product-related information access to legislative and regulatory information and access to on-line catalogs and ordering systems for various materials.

U.S. Patent Application Publication No. US 2002/0087430 A1, titled “Universal Shopping Basket” by Davis et.al., the content of which is herein incorporated by reference, discloses a universal shopping basket for purchasing products from e-commerce sites of multiple merchants using a single check-out process. The universal shopping cart is separate from the merchant whose products are to be purchased. According to the disclosure, information is gathered from a target merchant relating to available products for purchase and a purchase request is presented to the target merchant on behalf of the purchaser.

U.S. Patent Application Publication No. US 2003/0023514 A1, titled “Unified Automatic Online Marketplace and Associated Web Site Generation and Transaction System” by Adler et.al., the content of which is herein incorporated by reference, discloses a unified automatic online marketplace and associated seller website generation and transaction system. A software engine is configured to generate one or more customized websites for a seller, based on the seller's product or service data and website choices. The marketplaces may include a business-to-business marketplace and a business-to-consumer marketplace.

U.S. Pat. No. 6,725,222, titled “Automated On-Line Commerce Method and Apparatus Utilizing Shopping Servers Which Update Product Information on Product Selection” issued to Musgrove et.al., the content of which is herein incorporated by reference, discloses an on-line commerce method and apparatus whereby users can select product for purchase from plural merchant servers by examining product information stored on a shopping server. The user selects a product to buy from a merchant based on information in the database of a shopping server that is remote from the merchant server. Product information is verified by information communicated from the merchant server and presented to the user for confirmation of purchase. A buy procedure is performed on the merchant server if the user confirms the purchase.

U.S. Patent Application Publication No. US 2008/0306838 A1, titled “System and Method Of Bridging A Product Catalog From a Central E-Commerce Website to Remote Access” by Fleet et.al., the content of which is herein incorporated by reference, discloses a computer system that bridges information between first and second websites. Product information is created on a first website, and bridging code is created which relates to the product information. The bridging code is installed on the second website, thus establishing communication between the first and second websites and allowing for the display of product information on the second website. Product information updated on the first website is updated on the second website. Purchase transactions are processed for transactions based on product information displayed on the second website.

U.S. Patent Application Publication No. US 2008/0004972 A1, titled “System For Selling Products From Anonymous Distributors” by Ghanma et.al., the content of which is herein incorporated by reference, discloses a system for enabling a reseller website to sell products from distributors to a customer over a communications network. Distributors may post items for sale on a service provider's core database. Resellers can select information according to their business needs without identifying the distributor, allowing distributors to maintain numerous distribution channels without having to pay for advertising and sales expenses.

U.S. Pat. No. 7,324,964, titled “Method and Apparatus For Commerce Item Information Homogenization in Electronic Commerce System” and issued to Gronberg et.al., the content of which is herein incorporated by reference, discloses a system for use in an online merchant system for homogenizing the format of received commerce item information from at least two distinct online entities, storing and aggregating the commerce item information, providing a user interface that accesses and retrieves the aggregated commerce item information and displaying the commerce item information in the user's browser window. Commerce metrics can also be captured to relate the commercial activity of commerce items to be retrieved by the online entities.

### SUMMARY OF THE INVENTION

The invention relates to a system and method that allows a user to list or import information to a master website, where the master website then lists that information at multiple third party websites. Further, the system and method of the invention allows the user to update information in the master website in real time or for later batch processing, where the master website then updates the item information in the third party websites. Additionally, the system and method can automatically update the master item list of the master website in response to information from the third party websites, and then update the information across all of the third party websites. The system and method of the invention can also be used to list goods and services on, and update, multiple websites owned or controlled by the user, in addition to listing goods and services and updating information on third party websites.

In one embodiment, the user can list or import items for sale on a master item list at one master website, where the master website then lists that item on behalf of the user for sale at multiple e-commerce websites. Further, the system and method of the invention allows the user to update item information in the master website in real time or for later batch processing, where the master website then updates the item information in the listings of the e-commerce websites regardless of the different shopping carts, process and program languages of the various e-commerce websites. Additionally, when an item is sold at any of the e-commerce sites, the system and method can automatically update the master item list of the master website and update the availability of the item across all of the e-commerce websites.

The system and method of the invention thus allows a user to list and update information, such as regarding one or more items to be offered for sale, lease, sharing or auction, on a plurality of e-commerce websites at a single master website, or for a user to list and update item information on a plurality of his/her own different websites, without having to update each third party website, such as each e-commerce website, individually. The user logs onto the master website to upload or update item information. According to the system and method of the invention, the master website accesses third party websites, such as e-commerce websites, selected by the user and opens accounts for the user; uploads and updates item information on those third party websites; and, if applicable, distributes or collects funds on behalf of the user. Further, the system and method can track orders and report sales for the listed items to the user.

In one embodiment, the invention relates to a method for synchronizing item information between a master website and a plurality of e-commerce websites. A user opens a master website account and provides information on how to communicate and make payments, if applicable, to and from the master website. Alternatively, the user may use the master website without opening an account, in which case the master website will list the information on the third party websites under its own account. The user selects the third party websites that she would like to list information, such as an item for sale, and the master website retrieves information on the script language of each selected third party website. Alternatively, the master website may communicate with the third party website through an application programming interface (“API”) if provided by the third party website, in which case information regarding the API can be retrieved by the master website. In another embodiment, the master website may have ascertained information on how to communicate with the third party website through techniques such as screen scraping, spidering, database scraping, harvesting of catalogue information or any other automatic means of obtaining information on the third party website, which information may be retrieved by the master website. In another embodiment, combinations of these techniques may be retrieved by the master website to be used to communicate with the third party website.

The master website gathers information from the user sufficient to open an account on each third party website, or to log on if the user already has an account with any of the third party websites. The user inputs into the master website information regarding the information, such as the item or service to be offered for sale, lease sharing or auction. Using this item information from the user, the master website communicates with each third party website and opens an account in the name of the user, if necessary. In one embodiment, the master website can automatically open a user account on the third party website using information determined on how to communicate with the third party website and information provided by the user. In another embodiment, the user account on the third party website may be opened manually with human intervention.

The master website then communicates information to each third party website to list the information, such as an item for sale, under the user's name. If the user does not open a master website account, the master website will log on using its own account information and lists the information, such as the item for sale, under its own name. When an item is sold on one of the third party websites, information regarding the sale is communicated back to the master website where it is used to update stored item information if necessary. Updated item information is then communicated to the other third party websites, for example to remove an item from listing or to update the quantity of an item remaining for sale. The master website communicates information regarding the sale to the user for completion of the sale.

In another embodiment, the user can update information, such as item price or quantity, on the master website. The master website communicates updated information to the third party websites where the information is listed.

In another embodiment, the master website maintains an account with each third party website for payment of fees related to listings. A debit to the master website account is in turn debited to the user's account with the master website.

In another embodiment, the master website gathers Key Performance Indicators (“KPI”) from third party websites regarding views of information or sales data and reports the data to the user.

In another embodiment, a user can edit items listed for auction on a plurality of websites. The user can monitor the progress of the multiple auctions from the master website, and then edit the listed price to the highest bid for the item from among the selected auction sites. In another embodiment, the master website can cancel auctions at all listed e-commerce websites except for the site with the highest bid. In another embodiment, the master website can reset the minimum bid on all e-commerce websites to the highest bid at any one of the e-commerce websites. In another embodiment, the master website can increase the highest bid on all e-commerce websites to the highest bid at any one of the e-commerce websites.

In another embodiment, the invention relates to a computer-based system configured to synchronize information between a master website and a plurality of third party websites.

### DESCRIPTION OF THE DRAWINGS

The invention will be described with reference to the accompanying drawings, in which like elements are referenced with like numerals.

FIG. 1 is a flowchart depicting one embodiment of the system of the invention.

FIG. 2 depicts a page of the master website for selection of e-commerce sites and entry by a user of information sufficient for the master website to log onto an existing account of an e-commerce site, or to set up an account on the selected e-commerce sites.

FIG. 3 depicts a page of the master website for the user to provide information on an item to be listed for sale in this e-commerce template.

FIG. 4 depicts table entries regarding information for the master website to communicate with e-commerce websites, including script language, product data file, picture data file, user ID and originating site.

FIG. 5 depicts the master item list of the master website compiling all of the user's items listed among the selected e-commerce websites.

FIG. 6 depicts the synchronization page of the master website for the user to manage the listing of items among selected e-commerce websites.

FIG. 7 depicts KPI data gathered from e-commerce websites regarding sales data of items.

FIG. 8 is a schematic of one embodiment of a computer-based system configured to enable the system of the invention.

### DETAILED DESCRIPTION OF THE INVENTION

Although the description below is given in terms of the listing of information by a user of the master website for an item to be listed for sale, lease, sharing or auction on third party e-commerce websites, it is understood that this is not intended to limit the scope of the invention. The invention can similarly be employed to list any type of information, such as pictures, videos, audio files or any other information for any purpose, such as sharing, on any website, whether operated by the user or by a third party.

In one embodiment, the invention relates to a method performed by a device capable of accessing a master website over a communications network for synchronizing item information between a master website and a plurality of e-commerce websites. A user of the master website who has an item to sell accesses the URL of the master website and opens a master website account which typically requires the selection of a user name and a password to access the account. Once logged on to the master website account, the user may be issued a master website email address to be used for communications with the master website. Alternatively, the user may enter her own email address for use in communications. The user may be asked to enter payment information to facilitate payments between the user and the master website. From the master website, the user can select from a menu the e-commerce websites that she would like to list the item for sale. The master website may retrieve previously stored information regarding the script language of each selected e-commerce website, both for communicating with the website and for the shopping cart program used on each e-commerce website.

In some instances, the master website will communicate with the e-commerce website by use of an API through a series of calls using protocols such as XML. An API comprises a series of XML messages, each corresponding to a different function such as open accounts, post/delete items, etc. In other instances, automated techniques such as screen scraping, spidering, database scraping, harvesting of catalogue information or any other automatic means of obtaining information may be used to parse and analyze content on the e-commerce site that was originally written for human consumption in order to extract semantic data structures representative of that information that can be used and manipulated programmatically. For example, the master website may use such automated techniques to extract product listings and user information from a selected e-commerce website. Another technique that can be used to extract information and allow the master website to communicate with the selected e-commerce websites is Semantic Web, which can use, for example, the W3C family of specifications such as Resource Description Framework (RDF) to establish syntactic structures that describe data. Also, the master website can store information regarding the known architecture of numerous available shopping cart software and which shopping cart software product is used by different e-commerce websites. Knowledge of the shopping cart software allows the master website to locate and amend files and folders on e-commerce websites regarding product description, price, payment options and inventory, among others.

In another embodiment, combinations of these techniques may be retrieved by the master website to be used to communicate with the third party website. For example, the master website may host a mashup of any combination of these or other techniques to combine the results to gather information on communicating with an e-commerce site.

One way the master website obtains information on how to communicate information to the third party websites is by querying the various websites. The received responses to the queries can indicate information on how to communicate with each e-commerce website, including the particular shopping cart used by that website. In this same manner, if the user lists her own websites to list the item, the user can either provide information on how the master website can communicate with her website to the master website, or the master website can query the user's website as it queries other third party websites.

The master website queries the user for required information to log onto each selected e-commerce website and also to set up an account in the user's name on each selected e-commerce website, if the user does not already have an account. In one embodiment, the master website can automatically open a user account on the third party website using information determined on how to communicate with the third party website and information provided by the user. In another embodiment, the user account on the third party website may be opened manually with human intervention. In another embodiment, the master website may list the item on the e-commerce site on behalf of the user but using its own account.

The master website may charge fees for use of its services. Such fees may include monthly access fees; fees per item of information listed; fees per third party website where information is listed; fees in relation to the amount of a sale; or any combination of these or any other fees desired by the master website. Alternatively, the master website may sell advertising space and provide the services free to users.

The user also enters information into the master website regarding the item to be offered for sale on the selected e-commerce websites. This information is stored by the master website in a master item list. The master website then logs onto the e-commerce sites selected by the user and communicates the item information to each e-commerce website in a format to list that item for sale under the user's name. Alternatively, the item can be listed on the e-commerce site under the master website's account on behalf of the user.

When the item is sold on any one of the e-commerce websites, information regarding the sale is communicated back to the master website from the e-commerce website where it is used to update stored item information in the master item list if necessary. Updated item information is then communicated to the remaining e-commerce websites, for example to remove an item from listing or to update the quantity of the item remaining for sale. The master website communicates information regarding the sale to the user for completion of the sale and for charging fees, if applicable.

In one embodiment, the master website receives information from an e-commerce website that a listed item has been sold, which information may include item identification information; selling price; quantity sold; and purchaser contact information. The e-commerce website may also communicate information such as the method of payment and the method of shipping selected by the purchaser as well as fees charged by the e-commerce website for the listing of the item. The master website may communicate this information to the user via email, such as the email assigned to the user upon account formation or to an email address selected by the user. The user may communicate directly with the purchaser to finalize the sale and to ship the item. The user may transmit funds to the master website for the payment of fees charged by the e-commerce website as well as any fees charged by the master website for facilitating the transaction. In another embodiment, the master website may communicate with the purchaser on behalf of the user and complete the sale. Funds may be received by the master website from the purchaser of the item which may be credited to the user's account. The master website may transmit funds to the user after withdrawing fees charged by the e-commerce website as well as its own fee for facilitating the transaction. In another embodiment, the user may have listed an item which it does not physically possess. In this instance, the item may be shipped from a third party location where the item is located. The master website may coordinate shipping instructions to the third party for shipment of the item to the purchaser. Funds may be received by the master website from the purchaser of the item which may be credited to the user's account. The master website may transmit funds to the user after withdrawing fees charged by the e-commerce website as well as its own fee for facilitating the transaction.

In another embodiment, the master website may be listed as the seller of the item on the e-commerce website. In that instance, the master website may communicate with the purchaser and receive funds for payment of the purchase of the item. The master website may communicate shipment instructions to the user. The e-commerce website may charge listing fees to the master website account, which fees will be charged to the user on her master website account along with fees charged by the master website. In this instance, the master website may require confirmation of shipping and receipt of the item by the purchaser prior to releasing funds to the user.

There may also be fees charged by other e-commerce websites for listing the item, even if no sale is completed on those sites. The master website may coordinate the payment of these fees from the account of the user.

In another embodiment, the user may have to pay fees to the master website before being allowed to enter item information, or after entering item information but before selecting e-commerce websites for listing the item. The method and timing of charging the user fees by the master website is not limiting and can be handled in any manner desirable by the master website.

The system and method can be used by any user who can access the master website over any known or later developed communications network by any suitable device now known or later developed. Suitable devices include, but are not limited to, general purpose computers; laptop computers; thin clients; PDAs; cell phones; satellite phones; and smartphones. The device must be capable of rendering and displaying pages created by any markup language now known or later developed which are transmitted over the communications network by the master website by any web browser program now known or later developed. Suitable markup languages include, but are not limited, to, HTML and XHTML. Suitable web browser programs include, but are not limited to, Amaya™; AOL Explorer™; Avant™; Camino™; Dillo™; DocZilla™; ELinks™; Epiphany™; Flock™; Galeon™; Google Chrome™; iCab™; Internet Explorer™; Internet Explorer for Mac™; K-Meleon™; Konqueror™; Links™; Lynx™; Maxthon™; Midori™; Mosaic™; Mozilla™; Mozilla Firefox™; Netscape™; Netscape Browser™; Netscape Navigator™; Netscape Navigator 9™; NetSurf™; OmniWeb™; Opera™; Safari™; SeaMonkey™; Shiira™; Sleipnir™; WorldWideWeb™; and w3m™.

The master website comprises a plurality of web pages hosted on one or more servers accessed over the communications network by way of a locator address, such as a URL or URI. The one or more servers include or are in communication with a central processing unit (“CPU”), or processor; a communications link to the communications network; and one or more searchable databases.

A user who has an item to offer for sale accesses the master website through her web-enabled device. After entering the URL of the master website into the web browser program of the device, a communications link is established between the user's device (the “client”) and the master website server (the “server”). The user's device may access the master website over any wired or wireless network now known or later developed, for example via a WAN, LAN, MAN, Bluetooth, Ethernet, Wi-Fi, satellite, GSM or PCS. The master website may be hosted on a plurality of servers.

Once on the master website, the user is presented with a web page transmitted from the master website and rendered on the user's device that provides a number of options. One option is to set up an account on the master website. If the user does not already have a master website account, she may have to choose this option to use the services provided by the master website. To open an account, the user will provide identifying information for logging on at a later date, typically a user name and a password. The master website will typically store this information in a database for later retrieval. The user information may be stored as clear text or in encrypted or hashed form. In one embodiment, the user can use the master website without setting up an account.

Once the user has established a master website account, she can select the e-commerce websites that she would like to list her item for sale. E-commerce websites may include, but are not limited to, HomeFinder.com™; vimeo™; Yahoo! Shopping™; Megavideo™; backpage.com™; hulu™; eBay™; Google™; metacafe™; vidiLife™; Etsy™; amazon.com™; facebook™; eCrater™; overstock.com™; YouTube™; stickam the live community™; craigslist™; Hoobly™; oodle™; Dailymotion™; or Bonanzle™ The user may also list her own websites for listing her item for sale.

When the user selects one or more e-commerce websites, the master website retrieves previously stored information relating to each e-commerce website needed to log onto the e-commerce website, if the user already has an account, or to set up an account if the user does not already have an account. The master website also retrieves previously stored information regarding how to communicate with each selected e-commerce site, including the shopping cart, including the specific processes and procedures for conducting e-commerce with each such website. For example, such information may contain the location of fields, product files and the specific file name that contains product information, pricing and pictures in each selected e-commerce site and shopping cart. The master website uses the retrieved information on each e-commerce website to create a master item list associated with the user for each item to be listed for sale at each selected e-commerce website.

Once the user has selected the e-commerce websites she wants to list her item for sale, she will be asked to enter item information such as description of the item, item number, price and an uploaded picture. This list is non-exclusive, and the user may enter any combination of this information and also any other information that the master website or the user chooses. The master website then formats the item information as needed to communicate it to each selected e-commerce website and stores this in the master item list. The master website may also assign an internal identifier to each item for identification and tracking purposes.

After the user has entered item information, she can select how to synchronize entered items and selected e-commerce websites. One method is for the user to click on items listed in the master item list and drag that item to each e-commerce website to list the item. She can de-synchronize one or more items by reversing this step, or by deleting the item by selecting the item and then hitting the <Delete> button on the keyboard. The user may customize item information for each selected e-commerce, such as adjusting the price or quantity available. The user can synchronize, de-synchronize or revise item information at any time by logging onto the master website and repeating these steps from the master item list. In another embodiment, the user may select or deselect items using radio buttons for synchronization. The method by which a user manages item information is not limited by this description and can be accomplished by any method desired by the master website.

The master website communicates with each of the selected e-commerce websites to set up the listing of the item on that site on behalf of the user. As discussed, the communication may vary from site to site, depending on the structure of the e-commerce website, and information regarding how to communicate with each e-commerce website is stored in the master website database. When an item is sold or any other change occurs to the listing of an item, the updated information is communicated to the master website from the e-commerce website where the change occurred. The master website can update its own database to reflect the changed information and can then update the item listings on the other e-commerce sites where the item is listed. For example, if originally a user listed five (5) of a particular item for sale and one (1) sale was made on a first e-commerce website, information regarding that sale is communicated to the master website from the first e-commerce website. The master website updates its database and updates item listing information on the other e-commerce websites that only four (4) of the items are remaining for sale.

Information regarding the sale of an item is then transmitted from the master website to the user. Alternatively, the user can check her account at the master website to see if any items have been sold. The user can then complete the sale of the item either directly with the purchaser or the master website may facilitate the payment and shipment (if necessary) of the sold item to the purchaser.

In another embodiment, the master website gathers Key Performance Indicators (“KPI”) from the e-commerce sites regarding sales data of items and reports the data to the user. KPI may include such information as which e-commerce websites sell at higher rates; which products are selling and on what e-commerce websites; how does the demand for a product fluctuate over time; which cities have more demand for a product; and more.

In another embodiment, a user can edit items listed for auction on a plurality of websites. The user can monitor the progress of the multiple auctions from the master website, and then edit the listed price to the highest bid for the item from among the selected auction sites.

The master website may maintain an account with each e-commerce website for payment of fees related to item listings. A debit to the master website account can in turn be debited to the user's account with the master website.

In another embodiment, the invention relates to a system configured to synchronize item information between a master website and a plurality of e-commerce websites.

The system and method of the invention can also be used to list goods and services on, and update, multiple websites owned or controlled by the user, in addition to listing goods and services and updating information on third party websites.

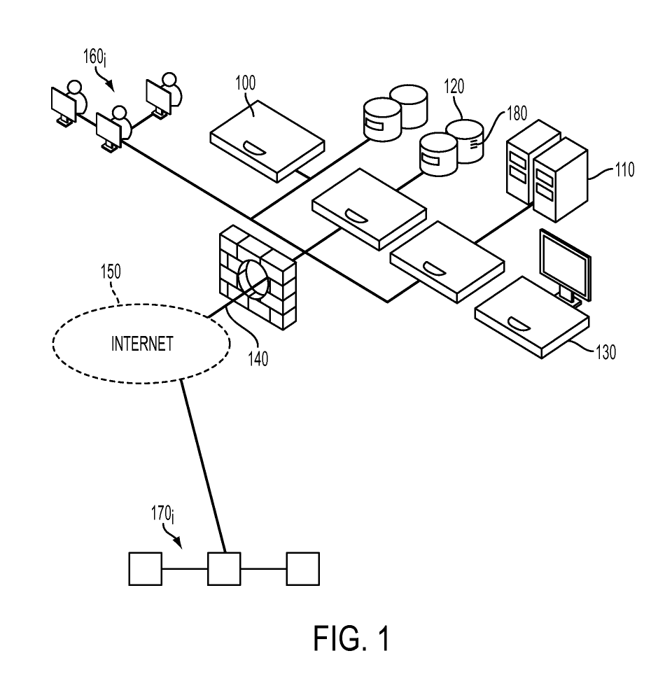

Turning to the figures, FIG. 1 depicts one embodiment of the system of the invention. The system comprises a master website 100 hosted on one or more servers 110. Master website 100 further comprises one or more databases 120, a programmable processor 130 and a communications link 140 to a communications network 150. Master website 100 is accessible over the communications network 150 to a plurality of users 160ᵢ as well as plurality of e-commerce websites 170ᵢ. Databases 120 are configured to store in master item list 180 information relating to a user 160ᵢ, one or more items that user 160ᵢ desires to sell on one or more e-commerce websites 170ᵢ. Databases 120 are further configured to store information relating to configuration of e-commerce websites 170ᵢ. Programmable processor 130 of master website 100 can be configured to access information in database 120 in response to inputs by user 160ᵢ, as well as to commands from master website 100 and communications received from e-commerce websites 170ᵢ.

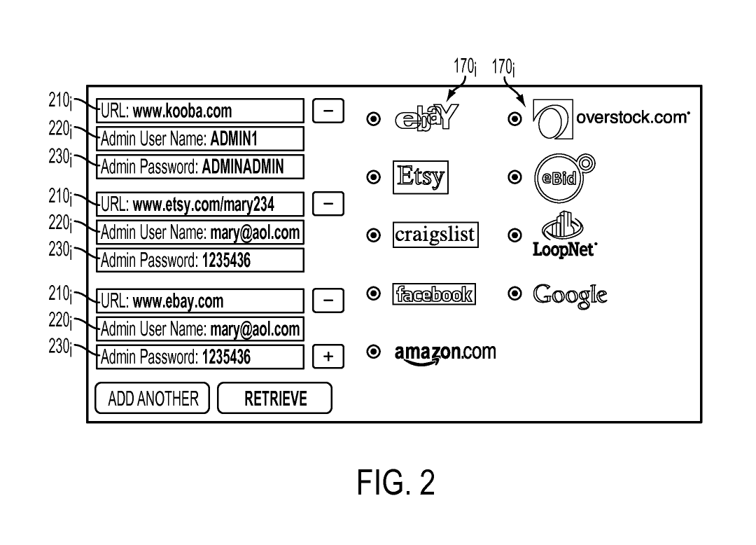

FIG. 2 depicts a page of master website 100 for entry by user 160ᵢ of information sufficient for master website 100 to log onto an existing account of an e-commerce site 170ᵢ, or to set up an account for user 160ᵢ on e-commerce site 170ᵢ. User information can include, but is not limited to, selected e-commerce websites 210ᵢ; user name to use for the user's account on each selected e-commerce website 220ᵢ; and a password to access user's account 230ᵢ.

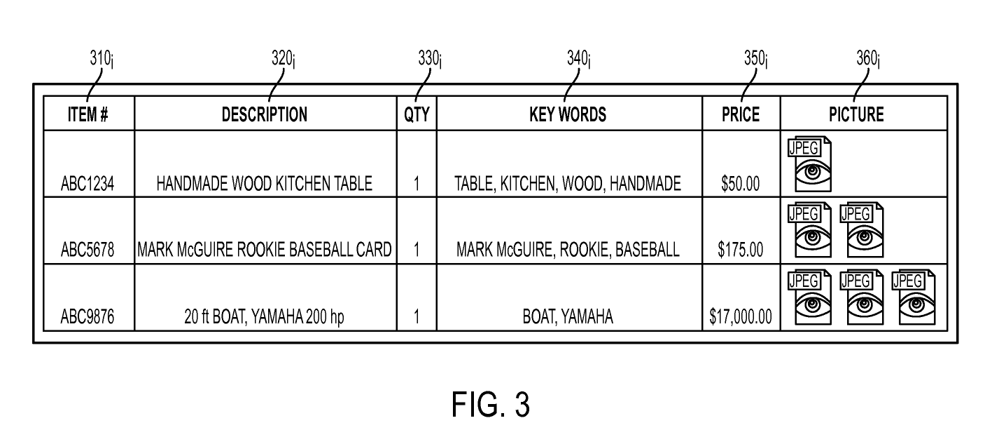

FIG. 3 depicts an e-commerce template of master website 100 for user 160ᵢ to provide information on an item to be listed for sale on an e-commerce website 170ᵢ. Item information can include, but is not limited to, an item number 310ᵢ selected by user 160ᵢ; item description 320ᵢ; item quantity 330ᵢ; keywords relating to item description 340ᵢ; item price 350ᵢ; and uploaded picture of item 360ᵢ.

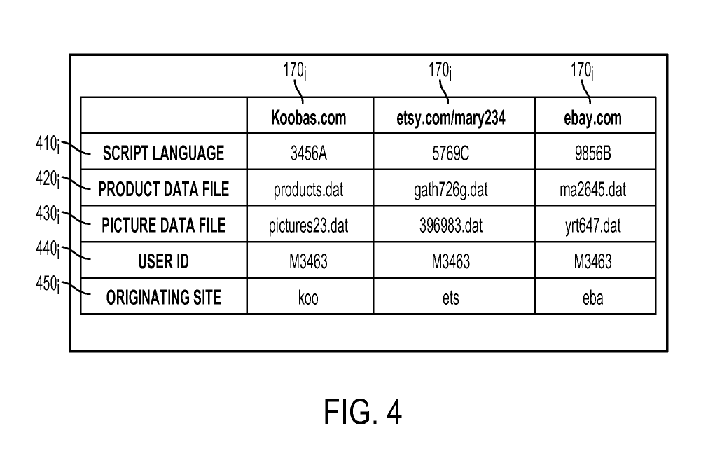

FIG. 4 depicts table entries in databases 120 regarding information for master website 100 to communicate with e-commerce websites 170ᵢ, including script language, API, information obtained through automatic techniques such as screen scraping, product data file, picture data file, user ID and originating site. Stored information regarding e-commerce websites 170ᵢ can include, but is not limited to, script language or other information 410ᵢ used to communicate with each e-commerce site 170ᵢ; product data file 420ᵢ for each item to be listed on that e-commerce website 170ᵢ; picture data file 430ᵢ for each item to be listed on that e-commerce website 170ᵢ; user name (id) 440ᵢ for logging onto that e-commerce website 170ᵢ; and an identifier 450ᵢ for each e-commerce website 170ᵢ. Identifier 450ᵢ may be used, for example, to label files in databases 120 to search for files containing information relating to each e-commerce website 170ᵢ.

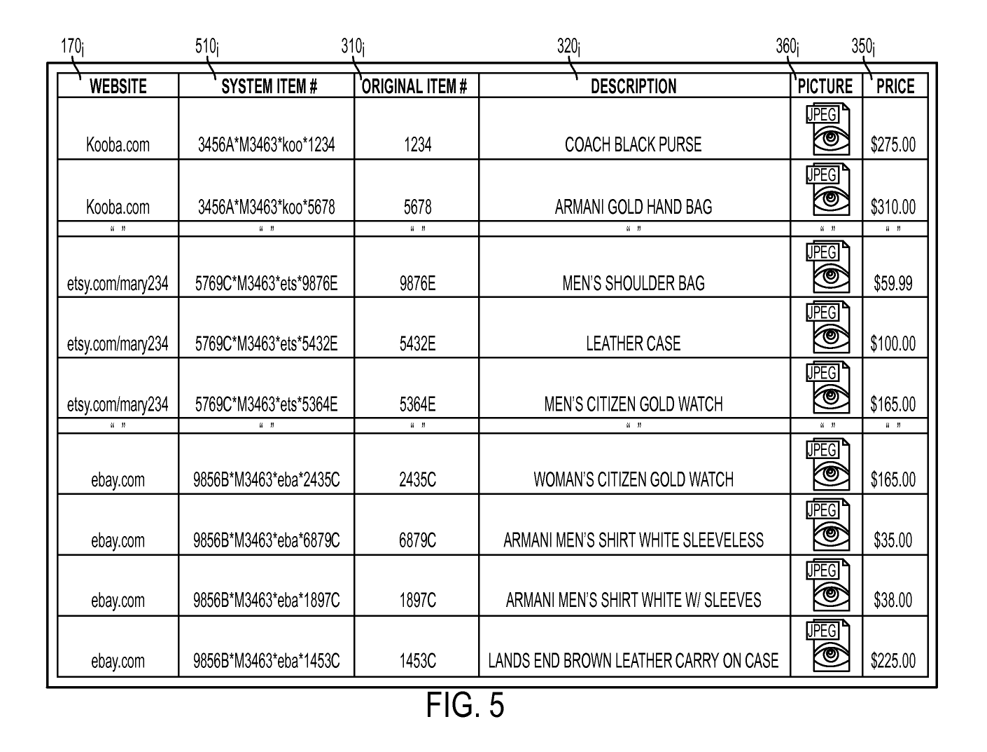

FIG. 5 depicts master item list 180 in databases 120 of master website 100 compiling all of user's 160ᵢ items listed among the selected e-commerce websites 170ᵢ. Master item list 180 may include, but is not limited to, selected e-commerce websites 170ᵢ for listing user's 160ᵢ items; item numbers 510ᵢ assigned by master website 100; user's 160ᵢ item numbers 310ᵢ; user's 160ᵢ item descriptions 320ᵢ; user 160ᵢ item picture files 360ᵢ; and selling price 350ᵢ.

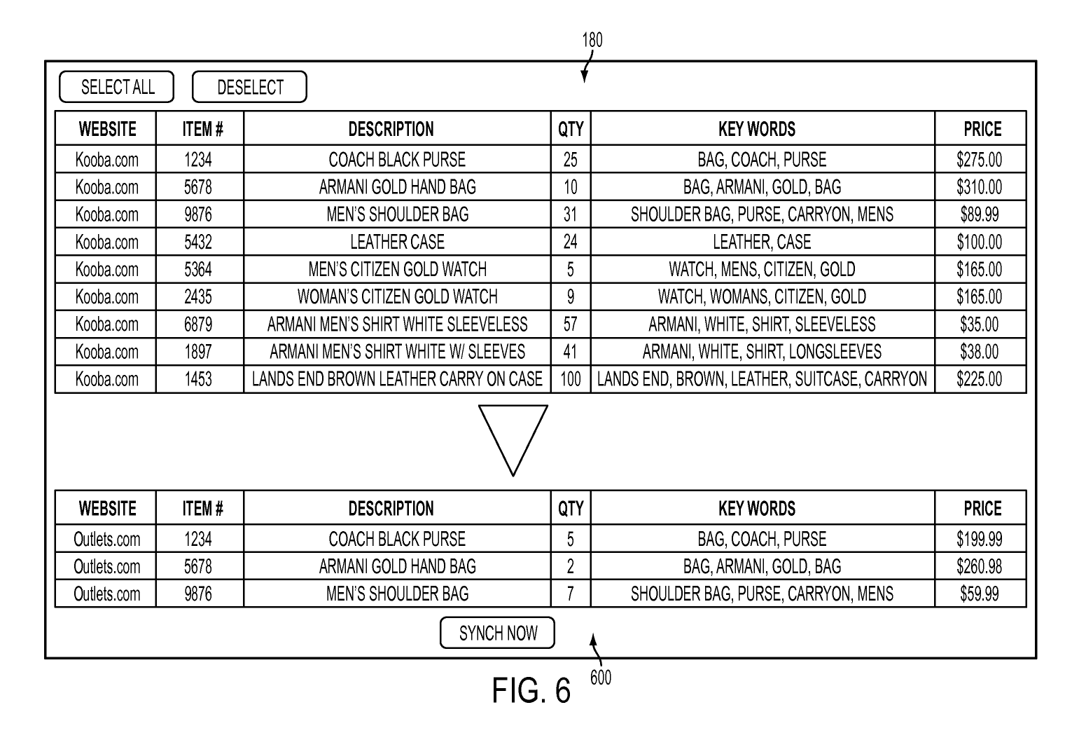

FIG. 6 depicts synchronization page of master website 100 for user 160ᵢ to manage the listing of items among selected e-commerce websites 170ᵢ. Synchronization page may include, but is not limited to, master item list 180 and synchronization list 600, which includes items listed on master item list 180 which user 160ᵢ would like to list on other e-commerce websites 170ᵢ.

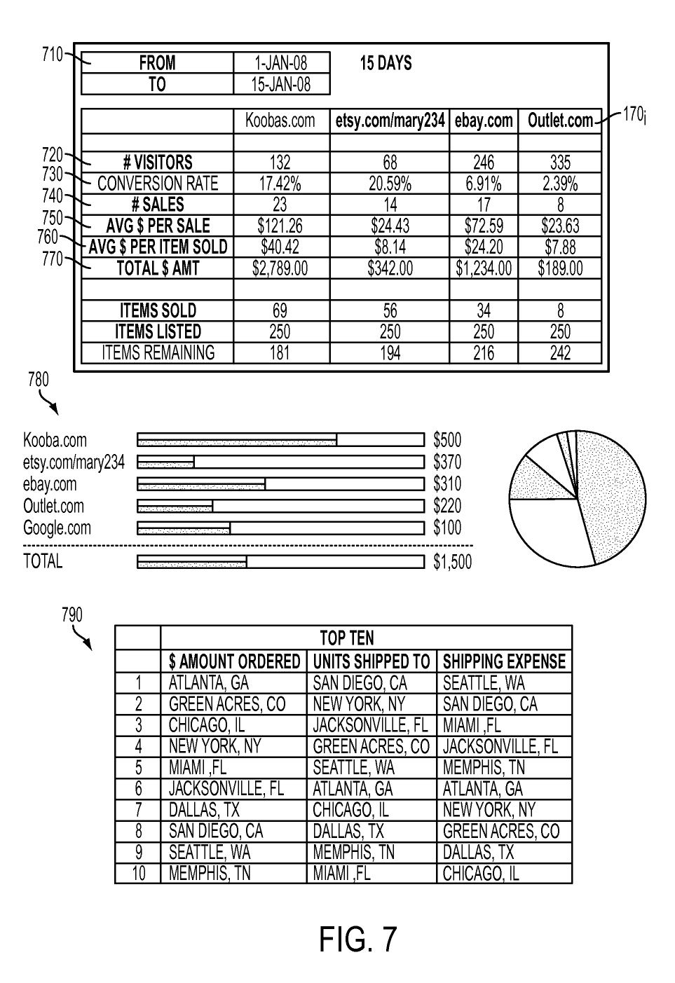

FIG. 7 depicts KPI data gathered from e-commerce websites 170ᵢ regarding sales data of items. KPI data can include, but is not limited to, data range of KPI data 710; e-commerce websites 170ᵢ from which KPI data are included in report; number of visitors 720 to each e-commerce website 170ᵢ;conversion rate of visitors to purchasing customers 730 at each e-commerce website 170ᵢ; number of sales 740 at each e-commerce website 170ᵢ; average dollar sale 750 at each e-commerce website 170ᵢ; average dollar sale per item sold 760 to each e-commerce website 170ᵢ; and total amount sold 770 at each e-commerce website 170ᵢ. KPI data can also compare statistics 780 for various e-commerce websites 170ᵢ as well as provide information on sales for specific geographical locations and related shipping statistics 790.

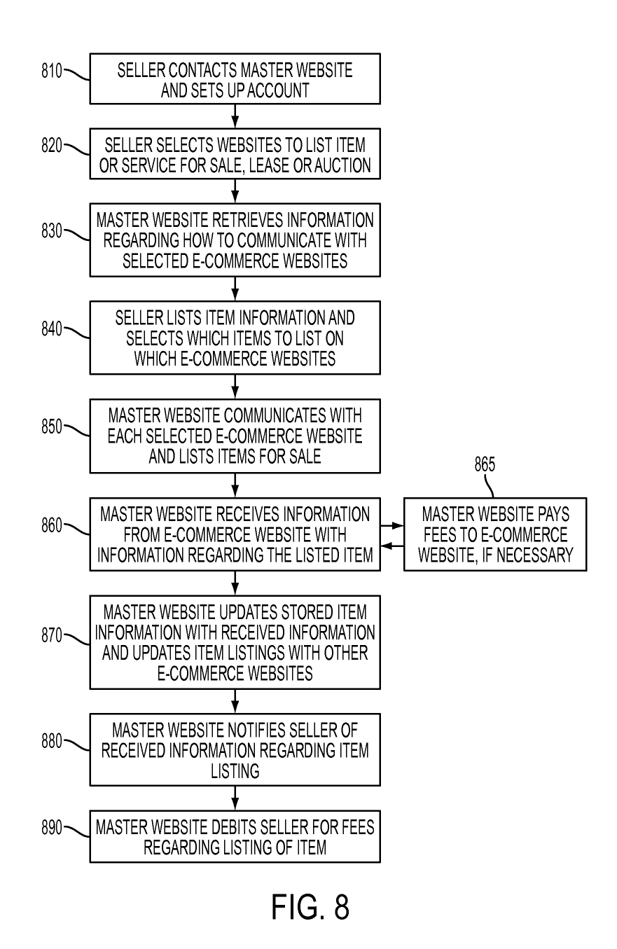

FIG. 8 depicts one embodiment of a computer-based system configured to enable the system of the invention. At 810, a user 160ᵢ contacts the master website 100 and sets up an account. At 820, user 160ᵢ selects e-commerce websites 170ᵢ to list an item or service for sale, lease or auction. At 830, master website 180 retrieves stored information 410ᵢ regarding how to communicate with each selected e-commerce website 170ᵢ. At 840, user 160ᵢ list item information and which item to list on which selected e-commerce website 170ᵢ. At 850, master website 180 communicates selected e-commerce websites 170ᵢ and lists the item or service for sale, lease or auction. At 860, master website 810 receives information from selected e-commerce websites 170ᵢ regarding the item listing. At 865, master website 100 pays fees due to e-commerce website 170ᵢ. At 870, master website 180 updates stored item information with received information and updates item listing with other e-commerce websites 170ᵢ. At 880, master website 180 notifies user 160ᵢ of received information regarding item listing. At 890, master website 180 debits user 160ᵢ for fees due regarding item listing.

The foregoing embodiments have been presented for the purpose of illustration and description only and are not to be construed as limiting the scope of the invention in any way. The scope of the invention is to be determined from the claims appended hereto.

1. A computerized method of simultaneously listing information on multiple third party websites comprising:
receiving first information from a user of a master website, where the first information is to be listed on a third party website, wherein further the master website stores the first information in at least one database, wherein further the first information comprises the architecture of shopping cart software on the third party website;
receiving second information from the user, where the second information regards the third party websites selected by the user where the first information is to be listed;
retrieving previously stored third information from a database regarding each third party website identified by the user; and
using at least some of the third information to communicate with each third party website identified by the user to list the first information.

2. The computerized method of claim 1, wherein the master website gathers the third information regarding each third party website by querying third party websites and storing the third information in the database.

3. The computerized method of claim 2, wherein the third information comprises scripting language.

4. The computerized method of claim 2, wherein the third information comprises an application programming interface.

5. The computerized method of claim 2, wherein the third information is acquired by the master website at least in part by screen scraping, spidering, database scraping, harvesting of catalogue information or any combination thereof

6. The computerized method of claim 1, wherein the user provides the third information to the master website.

7. The computerized method of claim 1, wherein the third party website comprises an e-commerce website.

8. The computerized method of claim 7, wherein the user comprises a seller and the first information comprises an item or service.

9. The computerized method of claim 8, wherein the item or service is to be offered for sale, lease, sharing or auction on the e-commerce website.

10. The computerized method of claim 9, wherein the first information comprises an audio or video file.

11. The computerized method of claim 9, wherein fourth information regarding a change in the status of the listing of the item or service on one of the selected e-commerce websites is communicated to the master website, wherein the master website updates the first information in its database and transmits the updated first information to the other selected e-commerce websites where the first information was listed.

12. A system for simultaneously listing items or services for sale, lease or auction on multiple e-commerce websites comprising:
a first communications interface configured to receive first information from a seller of an item regarding the item or service to be sold, leased or auctioned;
a seller data entry unit configured to receive second information from the seller regarding a plurality of e-commerce websites where the item or service is to be listed for sale, lease or auction;
a database configured to store third information regarding each e-commerce website identified by the seller, wherein the third information comprises the architecture of shopping cart software on the e-commerce website;
a second communications interface configured to communicate with each e-commerce website identified by the seller to list the item or service for sale, lease or auction and receive fourth information from each e-commerce website regarding the item or service listing;
a payment unit configured to pay fees to the selected e-commerce websites where the item or service was listed and to charge fees to the user for the listing of the item or service on the plurality of e-commerce websites; and
a reporting unit configured to report the fourth information received from each e-commerce website regarding the item or service listing to the seller.

13. The system of claim 12, wherein the master website gathers the third information regarding each e-commerce website by querying the e-commerce websites and storing the third information in the database.

14. The system of claim 13, wherein the third information comprises scripting language.

15. The system of claim 13, wherein the third information comprises an application programming interface.

16. The system of claim 13, wherein the third information is acquired by the master website at least in part by screen scraping, spidering, database scraping, harvesting of catalogue information or any combination thereof.

17. The system of claim 13, wherein the first information comprises an item or service.

18. The system of claim 17, wherein the item or service is to be offered for sale, lease, sharing or auction on the e-commerce website.

19. The system of claim 12, wherein the fourth information comprises a change in the status of the listing of the item or service on one of the selected e-commerce websites, wherein the fourth information is communicated to the master website, wherein the master website updates the first information in its database and transmits the updated first information to the other selected e-commerce websites where the first information was listed.

20. A computerized method of conducting simultaneous auctions on multiple third party websites comprising:
receiving first information from a user of a master website, where the first information comprises information to be listed on a third party website regarding the auction of a good or service, wherein further the master website stores the first information in at least one database, wherein further the first information comprises the architecture of shopping cart software on the third party website;
receiving second information from the user, where the second information regards the third party websites selected by the user where the first information is to be listed for auction;
retrieving previously stored third information from a database regarding each third party website identified by the user;
using at least some of the third information to communicate with each third party website identified by the user to list the good or service for auction using the first information;
receiving information from one of the third party websites regarding a change in status of the good or service for auction;
updating the first information with the change in status received from one of the third party websites; and
transmitting the updated first information to the other third party websites to reflect the change in the status of the good or service for auction at one of the third party websites,
wherein the change in status comprises a bid amount for the good or service.
